(19) United States
(12) Patent Application Publication
(10) Pub. No.: US 2008/0069621 A1
(43) Pub. Date: Mar. 20, 2008

(54) Tastatur

(75) Inventors: Horst Hubner, Bayreuth (DE); Karl-Heinz Muller, Auerbach/Opf. (DE); Dirk Schramm, Schwanstetten (DE)

Correspondence Address: ARNOLD & KNOBLOCH, L.L.P., 2401 FOUNTAIN VIEW DRIVE, SUITE 630, HOUSTON, TX, 77057, US

(73) Assignee: Cherry GmbH

(21) Appl. No.: 11/807,751

(22) Filed: May 30, 2007

(30) Foreign Application Priority Data
Jul. 10, 2006 (DE) 10 2006 031 854.4

(51) Int. Cl. G06F 3/02

(52) U.S. Cl. 400/472

(57) ABSTRACT

The invention relates to a keyboard comprising a housing upper part which has a key array area for arranging a plurality of keys, characterized in that the housing upper part is of wavy design in the key array area.

The invention relates to a keyboard for a computer.

Due to the enormous cost pressure on products in the computer sector, in the production of keyboards for computers there is a need for continual cost reduction, although the usability and functional reliability must be retained or even improved. Cost savings in the production of keyboards for computers can be achieved inter alia by using less material and by simplifying the production process.

In addition to a favourable price, competitive products are also characterized by advantageous properties that are different from competing products. In the case of keyboards, one such property is for example little noise when pressing the keys. The noise of pressing keys is perceived as disruptive by many computer users and may lead to a high noise level particularly in large offices where there are many users.

The object of the present invention is therefore to provide a keyboard which, compared to a keyboard according to the prior art, can be produced more cost-effectively due to material savings and simplifications in the production process and at the same time has improved properties with regard to the noise produced when pressing the keys.

This object is achieved by a keyboard according to the invention.

A keyboard according to the invention comprises a housing upper part which has a key array area for arranging a plurality of keys, wherein the housing upper part is of wavy design in the key array area.

A housing of a keyboard according to the invention preferably comprises a housing lower part and the housing upper part arranged on the housing lower part.

The housing upper part has an outer side and an inner side located opposite the outer side, wherein the outer side is the side of the housing upper part which is visible when the keyboard is assembled.

The key array area is a sub-area of the housing upper part in which a plurality of keys are grouped together to form a key array. In the key array area there may be arranged for example keys of a normal input area (typewriter keyboard), a number block, a cursor control key block or a function key block.

The housing upper part has guide domes in the key array area. The guide domes are preferably thin-walled, straight tubular pieces which protrude through the housing upper part and are fixed to the latter. Advantageously, the housing upper part is made in one piece from a plastic by means of an injection moulding process, so that the guide domes are integrally formed on the housing upper part. Through the tubular opening of a guide dome, a key button of a key is connected via a plunger to a key base part so that, when the keys are pressed, the downward and upward movement of the key button arranged on the outer side of the housing upper part can be transmitted via the plunger to the key base part in the interior of the keyboard.

The guide domes form a mechanical reinforcement against external bending and torsion forces. Between the guide domes, the housing upper part is structurally weakened in the key array area. In order to counteract this weakening, housing parts of keyboards according to the prior art are usually strengthened by reinforcing ribs in the region of the key array. However, the fitting of reinforcing ribs requires additional material and moulds of complicated shape. Furthermore, the customary accumulations of material at the base of the reinforcing ribs make it more difficult to control the temperature during the production process. Moreover, in the case of workpieces with reinforcing ribs, usually the workpiece shrinks onto the mould, which makes it more difficult to remove the finished workpiece.

A keyboard according to the invention overcomes the aforementioned disadvantages from the prior art by means of an inventive configuration of the housing upper part in the key array area. In a keyboard according to the invention, the housing upper part is of wavy design in the key array area, which increases the rigidity of the housing upper part and omits the need to fit reinforcing ribs, as a result of which a saving in terms of material is made in comparison to a keyboard according to the prior art. The wavy design of the housing upper part in the key array area utilizes the effect that a wavy two-dimensional component has a greater stiffness than a planar two-dimensional component.

The housing upper part has an approximately constant wall thickness in the key array area, which is advantageous for the production process due to the uniform material distribution associated therewith.

Advantageously, wave maxima and wave minima of the housing upper part, which is of wavy design in the key array area, run approximately parallel to the longitudinal axis of the keyboard so that the keys in the key array area are arranged on lines which are oriented parallel to the wave maxima and wave minima.

The housing upper part, which is of wavy design in the key array area, preferably has a wave minimum with respect to the outer side of the housing upper part at sides of the key array area which are parallel to the longitudinal axis of the keyboard, as a result of which a trough-like depression with a wavy bottom is produced in the key array area of the housing upper part.

In one preferred embodiment of a keyboard according to the invention, the housing upper part has further key array areas for arranging a plurality of keys, wherein the housing upper part is of wavy design in the further key array areas. In this embodiment, the keys of a normal input area (typewriter keyboard) may be arranged for example in a first key array area and the keys of a number block, a cursor control key block or a function key block may be arranged in the further key array areas.

Preferably, the housing upper part has in the further key array areas an approximately constant wall thickness and guide domes for the keys.

Preferably, wave maxima and wave minima of the housing upper part, which is of wavy design in the key array areas, are uniformly aligned over the key array areas, so that wave maxima and wave minima continue across boundaries between adjacent key array areas as if just one single, large key array area were present.

The invention will be explained in more detail below with reference to the drawings.

In the drawings:

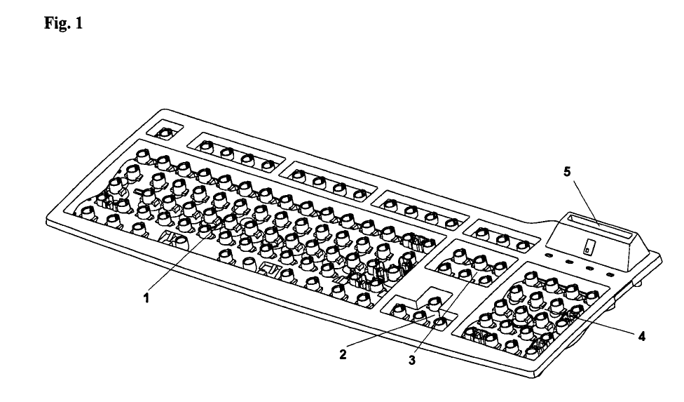

FIG. 1 shows a perspective view of the outer side of a preferred embodiment of a housing upper part of a keyboard according to the invention,

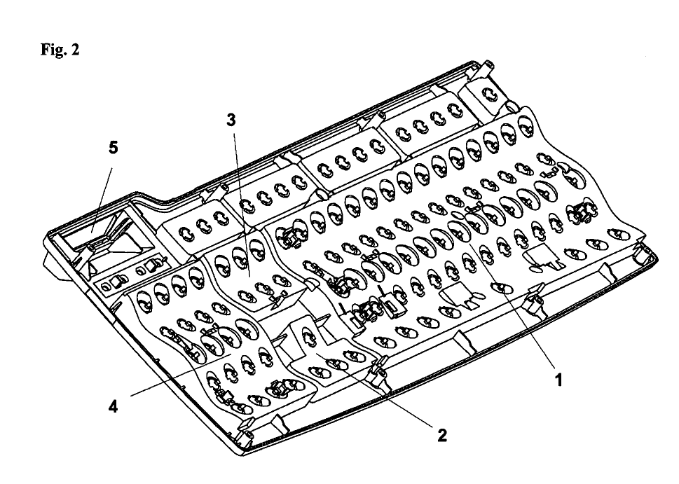

FIG. 2 shows a perspective view of the inner side of the preferred embodiment as shown in FIG. 1 of a housing upper part of a keyboard according to the invention, and

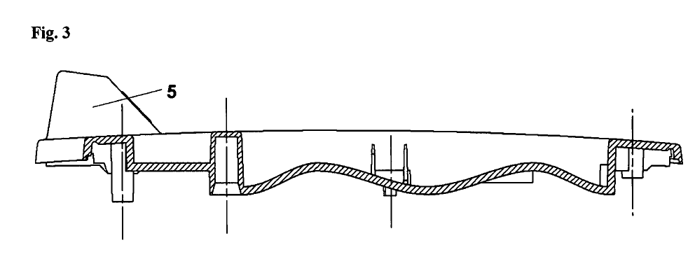

FIG. 3 shows a sectional view transverse to the longitudinal axis of the preferred embodiment shown in FIG. 1 of a housing upper part of a keyboard according to the invention.

FIG. 1 shows a perspective view of the outer side of a preferred embodiment of a housing upper part of a keyboard according to the invention. The housing upper part has on the bottom left a first key array area (1) which serves for arranging the keys of a normal input area (typewriter keyboard). A second key array area (2) and a third key array area (3) are arranged one above the other to the right of the first key array area (1). The key array area (2) serves for arranging the keys of a cursor control key block. A fourth key array area (4) can be seen on the bottom right, which serves for arranging the keys of a number block. Above the key array areas, the housing upper part has a row for further keys, such as function keys for example, and a card insertion slot (5). A plurality of guide domes is arranged in each of the four key array areas. For example, the second key array area (2) has four guide domes and the third key array area (3) has six guide domes. The tubular guide domes protrude from the housing upper part.

FIG. 2 shows a perspective view of the inner side of the preferred embodiment shown in FIG. 1 of a housing upper part of a keyboard according to the invention. In this figure, the card insertion slot (5) can be seen at the top left. Shown below it is the fourth key array area (4) for arranging the keys of a number block. Arranged one above the other to the right of the fourth key array area (4) are the second key array area (2) for arranging the keys of a cursor control key block and the third key array area (3). The first key array area (1) for arranging the keys of a normal input area (typewriter keyboard) can be seen at the bottom right. The row for further keys can be seen above the key array areas, to the right of the card insertion slot (5). The wavy design of the housing upper part in the four key array areas can clearly be seen from the diagram in FIG. 2. It can also be seen that wave maxima and wave minima of the housing upper part, which is of wavy design in the four key array areas, are aligned uniformly over the four key array areas so that the wave maxima and wave minima continue across the boundaries between the four key array areas as if the four key array areas were a single, large key array area. It can also be seen from FIG. 2 that the housing upper part, which is of wavy design in the four key array areas, has a wave maximum with respect to the inner side of the housing upper part shown in FIG. 2 at sides of the four key array areas which are parallel to the longitudinal axis of the housing upper part, as a result of which a trough-like depression with a wavy bottom is produced with respect to the outer side of the housing upper part in each of the four key array areas of the housing upper part. The tubular openings of the guide domes can be seen as drillholes in the housing upper part in the diagram shown in FIG. 2. In the illustrated embodiment, the housing upper part is not of wavy design in the region of the row for further keys. In a further preferred embodiment, the housing upper part may be of wavy design in this area too. It can be seen from FIG. 2 that a keyboard according to the invention does not have any reinforcing ribs in the key array areas.

FIG. 3 shows a sectional view transversely to the longitudinal axis of the preferred embodiment shown in FIG. 1 of a housing upper part of a keyboard according to the invention. In this figure, the card insertion slot (5) can be seen at the top left. The sectioned face runs transversely to the longitudinal axis of the housing upper part through the first key array area (1) and the row for further keys, while the card insertion slot (5) is located behind the sectioned face in the viewing direction, on the same side as the row for further keys. The surface of the housing upper part located in the sectioned face is shown hatched in the diagram in FIG. 3. In FIG. 3, the first key array area (1) corresponds to the wavy portion of the sectioned face. The first key array area (1) has a wave minimum at the left and right edge and in the centre. The width of the hatched area corresponds to the wall thickness of the housing upper part which, as can be seen from FIG. 3 for the first key array area (1), is approximately constant in the four key array areas.

A keyboard according to the invention does not require any reinforcing ribs in the key array areas. As a result, a saving in terms of material can be made in comparison to a keyboard according to the prior art. The shape of the moulds and the production process are also simplified.

Due to the inventive wavy design of the housing upper part in the key array areas, the noise produced when pressing the keys is also reduced, since the sound waves are not simply emitted upwards in the direction of a user, as is mainly the case with a flat surface, but rather are fanned out to the side too on account of the wavy profile.

The present invention thus provides a keyboard which can be produced more cost-effectively than a keyboard according to the prior art on account of material savings and simplifications in the production process, and which at the same time has improved properties with regard to the noise that is produced when pressing the keys.

### LIST OF REFERENCES

1 First key array area

2 Second key array area

3 Third key array area

4 Fourth key array area

5 Card insertion slot

1. A keyboard comprising a housing upper part which has a key array area for arranging a plurality of keys, characterized in that the housing upper part is of wavy design in the key array area.

2. The keyboard according to claim 1, wherein the housing upper part has guide domes in the key array area.

3. The keyboard according to any one of the preceding claims, wherein wave maxima and wave minima of the housing upper part, which is of wavy design in the key array area, run approximately parallel to the longitudinal axis of the keyboard.

4. The keyboard according to any one of the preceding claims, wherein the housing upper part, which is of wavy design in the key array area, has a wave minimum with respect to an outer side of the housing upper part at sides of the key array area which are parallel to the longitudinal axis of the keyboard.

5. The keyboard according to any one of the preceding claims, wherein the housing upper part has an approximately constant wall thickness in the key array area.

6. The keyboard according to any one of the preceding claims, wherein the housing upper part has further key array areas for arranging a plurality of keys, characterized in that the housing upper part is of wavy design in the further key array areas.

7. The keyboard according to the preceding claim, wherein the housing upper part has an approximately constant wall thickness in the further key array areas.

8. The keyboard according to any one of claims 6 to 7, wherein the housing upper part has guide domes in the further key array areas.

9. The keyboard according to any one of claims 6 to 8, wherein wave maxima and wave minima of the housing upper part, which is of wavy design in the key array areas, are uniformly aligned over the key array areas.
